(19) United States
(12) Patent Application Publication
(10) Pub. No.: US 2008/0038018 A1
(43) Pub. Date: Feb. 14, 2008

(54) Image Generating Apparatus

(75) Inventor: Kouichi Chikumoto, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/758,934

(22) Filed: Jun. 6, 2007

(30) Foreign Application Priority Data
Jun. 7, 2006 (JP) 2006-157935

(51) Int. Cl. G03G 15/02

(52) U.S. Cl. 399/176

(57) ABSTRACT

An image generating apparatus includes a side plate integrally provided with a bearing supporting a shaft of a platen roller and a U-shaped torsion spring for urging the shaft of the platen roller toward an axial first side, mounted on the side plate, in which the side plate integrally has a groove portion storing the U-shaped torsion spring and linked to a hole of the bearing, and a coupling portion covering an opening of the groove portion such that a through hole receiving the U-shaped torsion spring is formed by the coupling portion and the groove portion.

### BACKGROUND OF THE INVENTION

1. Field of the Invention

The present invention relates to an image generating apparatus, and more particularly, it relates to an image generating apparatus comprising a roller.

2. Description of the Background Art

An image generating apparatus comprising a roller is known in general. The roller is located by urging the same by a spring member or the like.

In a locating structure of a roller described in Japanese Patent Laying-Open No. 2001-341881, for example, a shaft of the roller is rotatably supported by a bearing and a first end of the shaft of the roller is fixed to a gear while a second end of the shaft of the roller is urged toward the first end of the shaft of the roller by an L-shaped plate spring so set as to come into contact with the second end of the shaft of the roller, thereby locating the roller. The first end of the L-shaped plate spring is fixed to a structure. In the locating structure of the roller described in the aforementioned Japanese Patent Laying-Open No. 2001-341881, a structure in which an L-shaped linear member is employed instead of the L-shaped plate spring is also disclosed. A first end of the linear member is mounted on the structure while a second end of the linear member is so mounted as to be wound around the shaft of the roller, thereby locating the roller. Although not specified, the first end of the L-shaped plate spring or linear member is conceivably fixed to or mounted on the structure by a screw or a dedicated mounting member.

In a locating structure of a roller described in Japanese Patent Laying-Open No. 2002-70841, both end of a shaft of the roller are supported by slidable guides. A first end of the shaft of the roller is located by a stop wall while a second end of the shaft of the roller is located by a curvable plate-like rib so provided as to come into contact with a second end of the shaft of the roller, and a stopper of the rib.

In a locating structure of a roller described in Japanese Patent Laying-Open No. 6-64774 (1994), both ends of a hollow driven roller arranged in parallel to a platen roller are located by employing spring bars. Each spring bar is so formed as to urge the driven roller against the platen roller, and is so mounted by fixing a first end of the spring bar to a structure with a mounting member, inserting a second end of the spring bar from a side end of the hollow roller and urge the driven roller against the platen roller, thereby fixing a position of the driven roller.

In a locating structure of a roller described in Japanese Patent Laying-Open No. 2004-250174, there is disclosed a structure in which a clutch for transmitting and disconnecting driving force to a shaft of a roller and the shaft of the roller are fixed to each other through a torsion spring. A circular arm is formed on a first end of the torsion spring, a coiled winding diameter portion is formed at the center of the torsion spring, and an arm closer to a fixing portion, for fixing the clutch is provided on the second end of the torsion spring. The circular arm of the first end of the torsion spring is hooked onto the shaft of the roller, the coiled winding diameter portion is fixed to a retention tool for stopping rotation provided closer to the clutch, and the arm closer to the fixing portion is fixed to a rotation stop member provided closer to the clutch, thereby fixing the clutch and the shaft of the roller.

In the locating structure of the shaft of the roller described in the aforementioned Japanese Patent Laying-Open No. 2001-341881, however, a screw or dedicated member for structurally fixing the first end of the L-shaped plate spring or linear member must be conceivably separately provided, whereby the number of components is disadvantageously increased. Additionally, the L-shaped plate spring or the L-shaped linear member is set on outside of the structure, whereby the roller must be protruded outward by at least the width of the L-shaped spring in order to urge the roller. Thus, the amount of protrusion of the roller in an axial direction from the structure is disadvantageously increased. Consequently, the size of the apparatus is disadvantageously increased.

In the method of locating the shaft of the roller described in the aforementioned Japanese Patent Laying-Open No. 2002-70841, the second end of the shaft of the roller has a structure in which the same is urged with the curvable rib, whereby a member for fixing the rib to the structure must be provided and a stopper for restricting the curvature range of the rib must be provided. Therefore, the number of components for urging the roller is disadvantageously increased. Additionally, a portion urging the roller is disadvantageously lengthened (increased) outward in the axial direction of the roller by the size of the stopper. Thus, the size of the apparatus is disadvantageously increased.

In the locating structure of the roller described in the aforementioned Japanese Patent Laying-Open No. 6-64774, the first ends of the spring bars are fixed to the structure by the mounting members respectively, whereby the number of components is disadvantageously increased due to the mounting portions. The spring bars inserted into the hollow portions of the roller from the side ends of the roller urge the roller in a direction perpendicular to the axial direction of the roller, whereby the position in the axial direction of the roller can not be disadvantageously fixed.

In the locating structure of the roller described in the aforementioned Japanese Patent Laying-Open No. 2004-250174, the torsion spring for fixing the shaft of the roller and the clutch urges the roller in a direction perpendicular to the axial direction of the roller, whereby the position in the axial direction of the roller can not be disadvantageously fixed.

### SUMMARY OF THE INVENTION

The present invention has been proposed in order to solve the aforementioned problems, and an object of the present invention is to provide an image generating apparatus capable of reducing the number of components for urging a roller while inhibiting the apparatus from being increased in size and capable of fixing a position of the roller in an axial direction.

An image generating apparatus according to a first aspect of the present invention comprises a chassis mounted with a print head, a platen roller against which the print head is pressed, a side plate mounted on a side surface of the chassis and integrally provided with a bearing supporting a shaft of the platen roller, and a U-shaped torsion spring for urging the shaft of the platen roller toward an axial first side, mounted on the side plate, wherein the side plate integrally includes a groove portion storing the U-shaped torsion spring and linked to a hole of the bearing, and a coupling portion covering an opening of the groove portion such that a through hole receiving the U-shaped torsion spring is formed by the coupling portion and the groove portion.

In the image generating apparatus according to the first aspect, as hereinabove described, the U-shaped torsion spring for urging the shaft of the platen roller toward the axial first side is mounted on the side plate integrally provided with the bearing supporting the shaft of the platen roller, whereby the shaft of the platen roller is urged toward the axial first side by the U-shaped torsion spring while the bearing of the side plate supports the shaft of the platen roller. Thus, the platen roller can be easily located in the axial direction. Additionally, the side plate includes the groove portion storing the U-shaped torsion spring and linked to the hole of the bearing so that the U-shaped torsion spring stored in the groove portion urges the platen roller, whereby a portion at which the platen roller is urged (torsion spring) can be inhibited from protruding outside the side plate. Thus, the apparatus can be inhibited from being increased in size. Further, the groove portion fixing the U-shaped torsion spring integrally includes the side plate, whereby no member for fixing the U-shaped torsion spring may be separately provided. Thus, the number of components for urging the platen roller can be reduced. Furthermore, the groove portion includes the coupling portion covering the opening of the groove portion so as to form the through hole receiving the U-shaped torsion spring, whereby the U-shaped torsion spring is mounted by passing the same through the coupling portion. Thus, the coupling portion can inhibit the U-shaped torsion spring from dropping.

In the aforementioned image generating apparatus according to the first aspect, the coupling portion is preferably so formed as to be arranged at a position opposed to the vicinity of the center of the U-shaped torsion spring when the U-shaped torsion spring is stored in the groove portion. According to this structure, the coupling portion and the vicinity of the center of the U-shaped torsion spring are opposed to each other. Thus, the U-shaped torsion spring can be inhibited from dropping from the opening of the groove portion due to an impact such as drop.

In the aforementioned image generating apparatus according to the first aspect, a first end of the U-shaped torsion spring is preferably arranged in the hole of the bearing while a second end of the U-shaped torsion spring is preferably arranged in the groove portion, and a contact portion for inhibiting the second end of the U-shaped torsion spring from moving toward an axial second side of the platen roller is preferably provided at a portion of the groove portion at which at least the second end of the U-shaped torsion spring is arranged. According to this structure, the contact portion receives force applied to the second end of the U-shaped torsion spring also in the case where force running axially outward (toward axial second side) is applied to the second end of the U-shaped torsion spring following the application of force running axially outward from the platen roller to the first end of the U-shaped torsion spring due to an impact such as drop. Thus, the second end of the U-shaped torsion spring can be inhibited from moving toward the axial second side of the platen roller to drop.

In this case, the contact portion is preferably formed in a plate shape so as to cover an opening of the groove portion in the vicinity of the second end of the U-shaped torsion spring. According to this structure, the second end of the U-shaped torsion spring can be easily inhibited from moving toward the axial second side of the platen roller to drop.

In the aforementioned image generating apparatus in which the groove portion includes the contact portion, a protrusion for inhibiting the U-shaped torsion spring from moving toward the axial first side of the platen roller is preferably provided in the vicinity of the contact portion of the groove portion. According to this structure, the portion in the vicinity of the second end of the U-shaped torsion spring is supported so as to be held between the protrusion and the contact portion. Thus, the second end of the U-shaped torsion spring can be inhibited from slipping off from the groove portion.

In this case, the length in a protruding direction of the protrusion is preferably so formed as to be larger than at least the wire diameter of the U-shaped torsion spring. According to this structure, the U-shaped torsion spring can be easily inhibited from dropping over the protrusion.

In the image generating apparatus in which the length in the protruding direction of the protrusion is so formed as to be lager than at least the wire diameter of the U-shaped torsion spring, the protrusion is preferably provided on a first inner surface of the groove portion, and the length in a protruding direction of the protrusion is preferably so adjusted as to have a clearance larger than at least the wire diameter of the U-shaped torsion spring between the protrusion and a second inner surface opposite to the protrusion. According to this structure, the U-shaped torsion spring can be stored in the groove portion through the clearance due to the existence of the clearance larger than at least the wire diameter of the U-shaped torsion spring between the protrusion and the second inner surface opposite to the protrusion.

In the aforementioned image generating apparatus according to the first aspect, a portion of a first end of the U-shaped torsion spring coming into contact with the shaft of the platen roller is preferably formed in an annular shape. According to this structure, strength of the portion of the U-shaped torsion spring coming into contact with the platen roller can be improved due to the annular portion.

In the aforementioned image generating apparatus according to the first aspect, a second end of the U-shaped torsion spring is preferably formed in a linear shape. According to this structure, the second end of the U-shaped torsion spring can be passed through the through hole formed between the opening of the groove portion and the coupling portion. Thus, the U-shaped torsion spring can be easily stored in the groove portion.

An image generating apparatus according to a second aspect of the present invention comprises a chassis mounted with a print head, a platen roller against which the print head is pressed, and a side plate mounted on a side surface of the chassis and integrally provided with a bearing supporting a shaft of the platen roller and further comprises a U-shaped torsion spring for urging the shaft of the platen roller toward an axial first side, mounted on the side plate, wherein the side plate integrally includes a groove portion storing the U-shaped torsion spring and linked to a hole of the bearing, and a coupling portion covering an opening of the groove portion such that a through hole receiving the U-shaped torsion spring is formed by the coupling portion and the groove portion, a first end of the U-shaped torsion spring is arranged in the hole of the bearing while a second end of the U-shaped torsion spring is arranged in the groove portion, a contact portion for inhibiting the second end of the U-shaped torsion spring from moving toward an axial second side of the platen roller is provided at a portion of the groove portion at which at least the second end of the U-shaped torsion spring is arranged, a protrusion for inhibiting the U-shaped torsion spring from moving toward the axial first side of the platen roller is provided in the vicinity of the contact portion of the groove portion, and a portion of a first end of the U-shaped torsion spring coming into contact with the shaft of the platen roller is formed in an annular shape.

In the image generating apparatus according to the second aspect, as hereinabove described, the U-shaped torsion spring for urging the shaft of the platen roller toward the axial first side is mounted on the side plate integrally provided with the bearing supporting the shaft of the platen roller, whereby the shaft of the platen roller is urged toward the axial first side by the U-shaped torsion spring while the bearing of the side plate supports the shaft of the platen roller. Thus, the platen roller can be easily located in the axial direction. Additionally, the side plate includes the groove portion storing the U-shaped torsion spring and linked to the hole of the bearing so that the U-shaped torsion spring stored in the groove portion urges the platen roller, whereby a portion at which the platen roller is urged (torsion spring) can be inhibited from protruding outside the side plate. Thus, the apparatus can be inhibited from being increased in size. Further, the groove portion fixing the U-shaped torsion spring integrally includes the side plate, whereby no member for fixing the U-shaped torsion spring may be separately provided. Thus, the number of components for urging the platen roller can be reduced. Furthermore, the side plate includes the coupling portion covering the opening of the groove portion so as to form the through hole receiving the U-shaped torsion spring, whereby the U-shaped torsion spring is mounted by passing the same through the coupling portion. Thus, the coupling portion can inhibit the U-shaped torsion spring from dropping. The contact portion is provided at the portion of the groove portion at which at least the second end of the U-shaped torsion spring is arranged, whereby the contact portion receives force applied to the second end of the U-shaped torsion spring also in the case where force running axially outward (toward axial second side) is applied to the second end of the U-shaped torsion spring following the application of force running axially outward from the platen roller to the first end of the U-shaped torsion spring due to an impact such as drop. Thus, the second end of the U-shaped torsion spring can be inhibited from moving toward the axial second side of the platen roller to drop. The protrusion for inhibiting the U-shaped torsion spring from moving toward the axial first side of the platen roller is provided in the vicinity of the contact portion of the groove portion, whereby the portion in the vicinity of the second end of the U-shaped torsion spring is supported so as to be held between the protrusion and the contact portion. Thus, the second end of the U-shaped torsion spring can be inhibited from slipping off from the groove portion. The portion of the first end of the U-shaped torsion spring coming into contact with the shaft of the platen roller is preferably formed in an annular shape, whereby strength of the portion of the U-shaped torsion spring coming into contact with the platen roller can be improved due to the annular portion.

In the aforementioned image generating apparatus according to the second aspect, the coupling portion is so formed as to be arranged at a position opposed to the vicinity of the center of the U-shaped torsion spring when the U-shaped torsion spring is stored in the groove portion. According to this structure, the coupling portion and the vicinity of the center of the U-shaped torsion spring are opposed to each other. Thus, the U-shaped torsion spring can be inhibited from dropping from the opening of the groove portion due to an impact such as drop.

In the aforementioned image generating apparatus according to the second aspect, the contact portion is preferably formed in a plate shape so as to cover an opening of the groove portion in the vicinity of the second end of the U-shaped torsion spring. According to this structure, the second end of the U-shaped torsion spring can be easily inhibited from moving toward the axial second side of the platen roller to drop.

In the aforementioned image generating apparatus according to the second aspect, the length in a protruding direction of the protrusion is preferably so formed as to be larger than at least the wire diameter of the U-shaped torsion spring. According to this structure, the U-shaped torsion spring can be easily inhibited from dropping over the protrusion.

In this case, the protrusion is provided on a first inner surface of the groove portion, and the length in a protruding direction of the protrusion is so adjusted as to have a clearance larger than at least the wire diameter of the U-shaped torsion spring between the protrusion and a second inner surface opposite to the protrusion. According to this structure, the U-shaped torsion spring can be stored in the groove portion through the clearance due to the existence of the clearance larger than at least the wire diameter of the U-shaped torsion spring between the protrusion and the second inner surface opposite to the protrusion.

In the aforementioned image generating apparatus according to the second aspect, the second end of the U-shaped torsion spring is preferably formed in a linear shape. According to this structure, the second end of the U-shaped torsion spring can be passed through the through hole formed between the opening of the groove portion and the coupling portion. Thus, the U-shaped torsion spring can be easily stored in the groove portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an overall structure of a thermal transfer printer according to an embodiment of the present invention;

FIG. 2 is a sectional view of the thermal transfer printer according to the embodiment of the present invention shown in FIG. 1;

FIG. 3 is a perspective view showing the thermal transfer printer shown in FIG. 1, from which the print head is removed;

FIG. 4 is an exploded perspective view of the thermal transfer printer according to the embodiment of the present invention shown in FIG. 3;

FIG. 5 is a perspective view of a portion at which a platen roller according to the embodiment of the present invention is urged;

FIG. 6 is an exploded perspective view of the portion at which the platen roller according to the embodiment of the present invention is urged;

FIG. 7 is a sectional view of the portion at which the platen roller according to the embodiment of the present invention is urged;

FIG. 8 is a front elevational view showing a surface of a first side plate according to the embodiment of the present invention, mounted on a chassis;

FIG. 9 is an enlarged front elevational view of a portion of the first side plate according to the embodiment of the present invention shown in FIG. 8, at which the platen roller is urged;

FIG. 10 is a front elevational view showing the portion shown in FIG. 9, from which a U-shaped torsion spring is removed;

FIG. 11 is a front elevational view showing a side surface opposite to the surface of the first side plate according to the embodiment of the present invention mounted on the chassis;

FIG. 12 is an enlarged front elevational view of a portion of the first side plate according to the embodiment of the present invention shown in FIG. 11, at which the platen roller is urged;

FIG. 13 is a perspective view of the U-shaped torsion spring according to the embodiment of the present invention; and

FIGS. 14 and 15 are perspective views for illustrating a procedure for mounting the U-shaped torsion spring according to the embodiment of the present invention on a groove portion.

### DESCRIPTION OF THE PREFERRED EMBODIMENTS

An embodiment of the present invention will be hereinafter described with reference to the drawings.

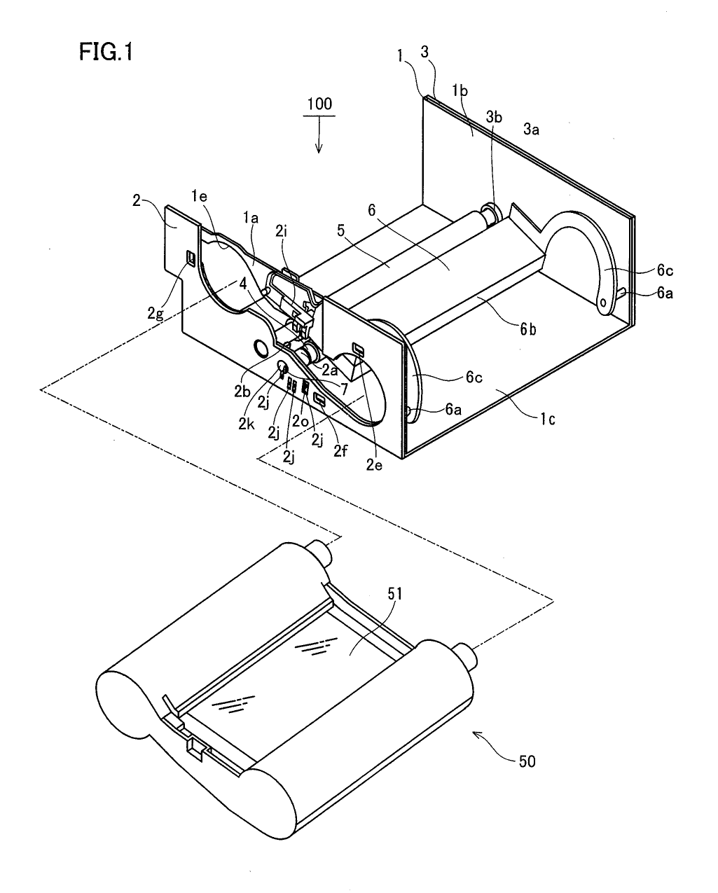

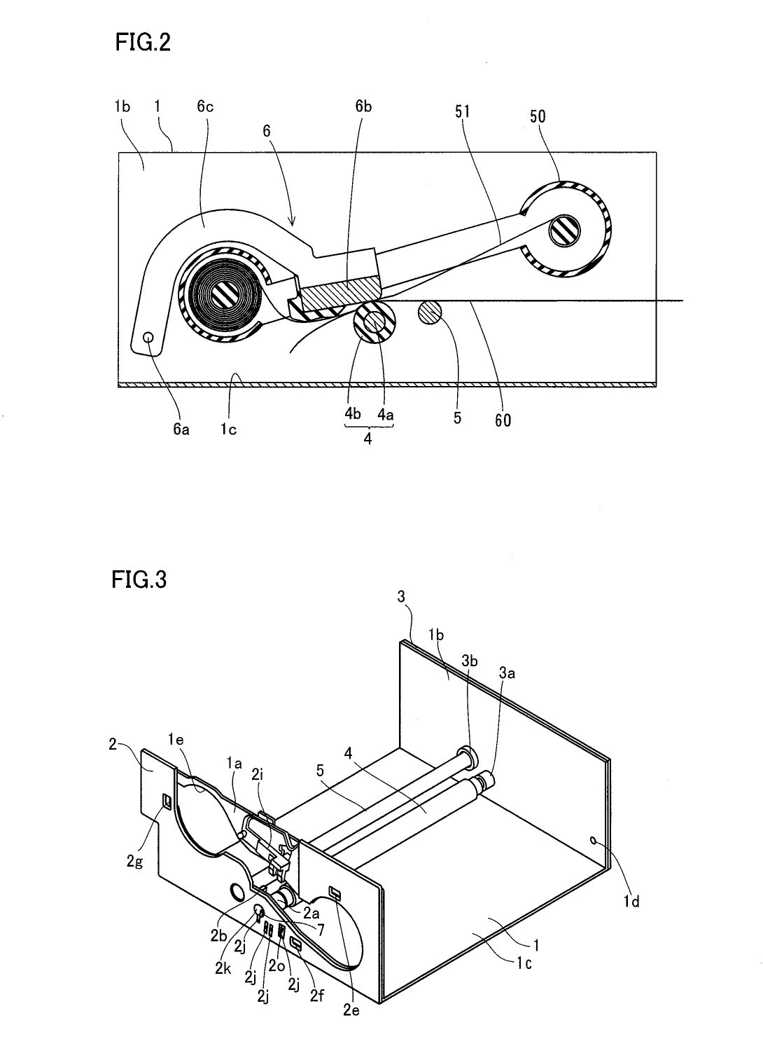

A thermal transfer printer 100 according to this embodiment comprises a chassis 1 made of metal, a first side plate 2 and a second side plate 3 made of resin mounted on a side surface of the chassis 1, a platen roller 4 including a shaft portion 4a made of metal and a roller portion 4b made of rubber mounted on an outer peripheral portion of the shaft portion 4a, a paper feed roller 5 made of metal, and a print head 6 for printing characters (pictures), as shown in FIGS. 1 to 5. The thermal transfer printer 100 is detachably mounted with an ink sheet cartridge 50 as shown in FIGS. 1 and 2.

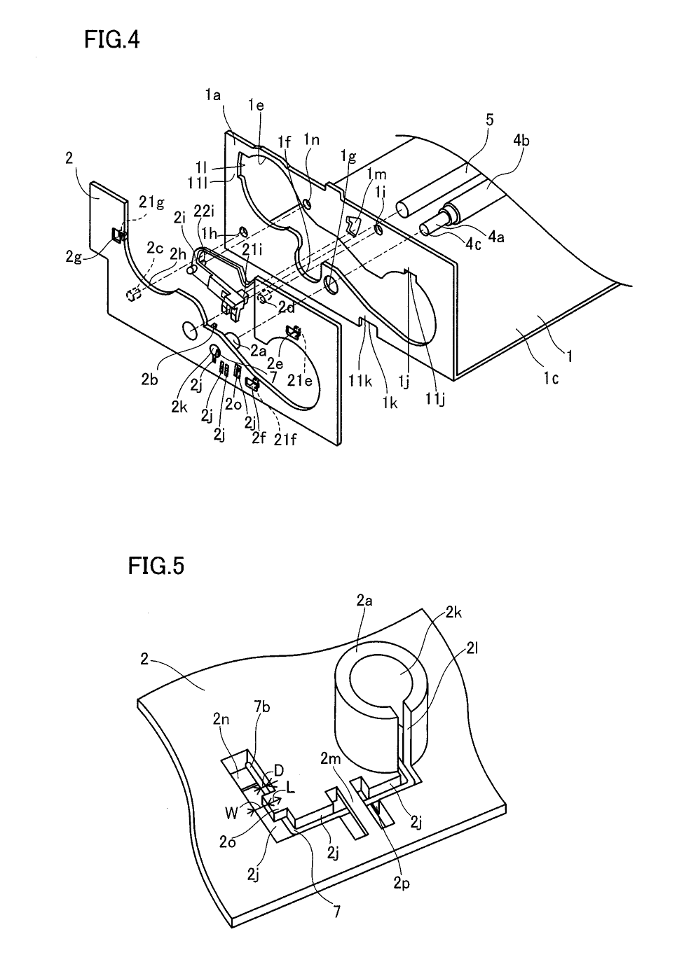

The chassis 1 has first and second side surfaces 1a and 1b opposed to each other and a bottom surface 1c coupling the first and second side surfaces 1a and 1b. Support holes id for rotatably supporting the print head 6 are provided on the first and second side surfaces 1a and 1b of the chassis 1 respectively. An ink sheet cartridge receiving hole 1e for receiving an ink sheet cartridge 50 is provided on the first side surface 1a as shown in FIG. 1. The ink sheet cartridge receiving hole 1e is provided with a notch if receiving a paper feed roller bearing 2b integrally formed in the first side plate 2 as shown in FIG. 4.

A round hole 1g and locating holes 1h and 1i of the first side plate 2 are provided on the first side surface 1a of the chassis 1. Rectangular notches 1j, 1k and 1l are provided on the first side surface 1a of the chassis 1. Engaging portions 11j, 11k and 11l engaging with after-mentioned stop sections 2e, 2f and 2g of the first side plate 2 are provided in the vicinity of the rectangular notches 1j, 1k and 1l. A stop portion 1m movably engaged with a stop section 21i of a slip-off preventing stopper 2i for preventing the ink sheet cartridge 50 from slipping off, and a hole in receiving a boss 22i for locating the slip-off preventing stopper 2i are provided on the first side surface 1a of the chassis 1.

As shown in FIGS. 1 and 2, a platen roller bearing 2a supporting the platen roller 4, the paper feed roller bearing 2b supporting the paper feed roller 5, bosses 2c and 2d for locating the first side plate 2 with respect to the first side surface 1a of the chassis 1, hooked stop sections 2e, 2f and 2g for mounting the first side plate 2 on the first side surface 1a of the chassis 1 are integrally provided on an inner surface, mounted on the chassis 1, of the first side plate 2 made of resin, to protrude from the first side plate 2 toward the first side surface 1a of the chassis 1. The first side plate 2 is provided with a notch 2h for receiving the ink sheet cartridge 50 when the first side plate 2 is mounted on the first side surface 1a of the chassis 1. The first side plate 2 is provided with the slip-off preventing stopper 2i for preventing the ink sheet cartridge 50 from slipping off in printing. The slip-off preventing stopper 2i is provided with the stop section 21i engaging with the stop portion 1m of the first side surface 1a of the chassis 1, and the boss 22i for locating the slip-off preventing stopper 2i. The second side plate 3 is integrally provided with the platen roller bearing 3a rotatably supporting the platen roller 4 and a paper feed roller bearing 3b rotatably supporting the paper feed roller 5.

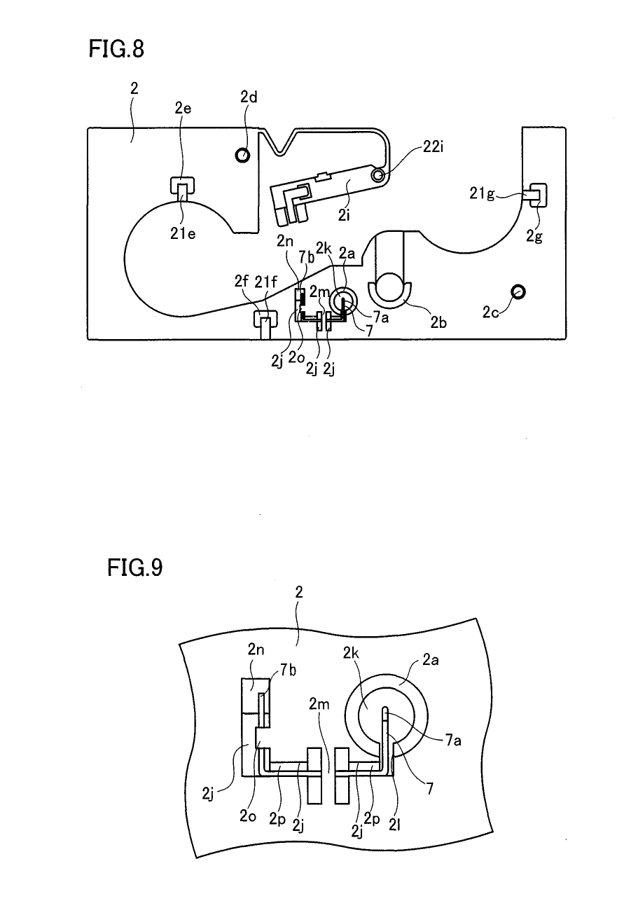

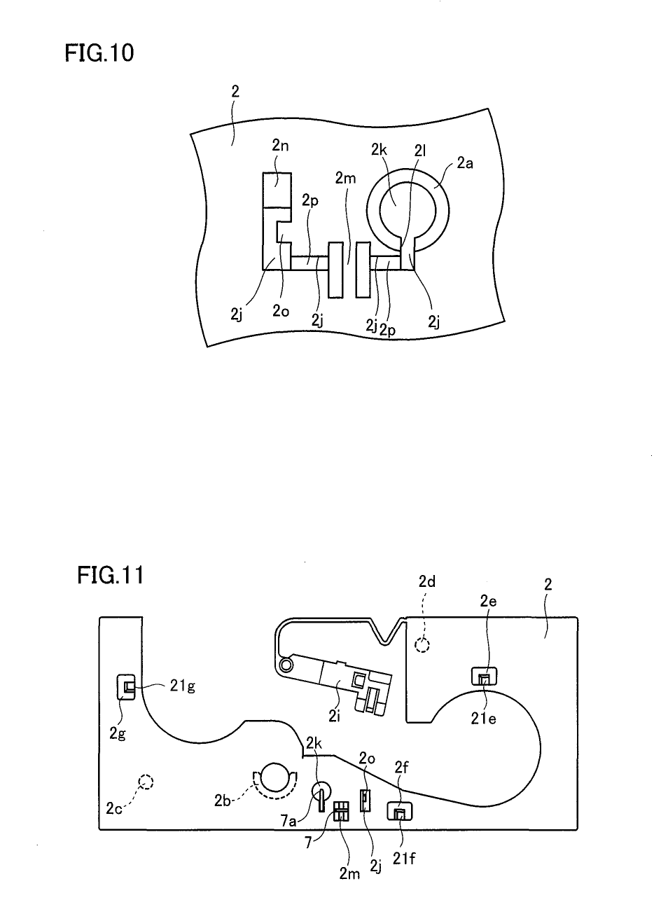

According to this embodiment, a groove portion 2j storing a U-shaped torsion spring 7 for urging the shaft portion 4a of the platen roller 4 toward an axial first side (along arrow Al) is provided in the first side plate 2 as shown in FIG. 5 and FIGS. 7 to 11. The groove portion 2j is so formed as to be linked to a hole 2k of the platen roller bearing 2a. In other words, a slit portion 2l for connecting the hole 2k of the platen roller bearing 2a and the groove portion 2j is provided in the platen roller bearing 2a. A first end 7a of the U-shaped torsion spring 7 is arranged in the hole 2k of the platen roller bearing 2a throught the slit portion 2l. A coupling portion 2m covering an opening of the groove portion 2j is so provided in the groove portion 2j as to form a through hole receiving the U-shaped torsion spring 7. According to this embodiment, the coupling portion 2m is so formed as to be arranged at a position opposite to the vicinity of the center of the U-shaped torsion spring 7 when the U-shaped torsion spring 7 is stored in the groove portion 2j.

According to this embodiment, a contact portion 2n for inhibiting a second end 7b of the U-shaped torsion spring 7 from moving toward an axial second side of the platen roller 4 (along arrow B1) is provided at a portion of the groove portion 2j in which the second end 7b of the U-shaped torsion spring 7 is arranged, as shown in FIG. 5. According to this embodiment, a contact portion 2n is formed in a plate shape so as to cover an opening of the groove portion 2j in the vicinity of the second end 7b of the U-shaped torsion spring 7.

According to this embodiment, a protrusion 20 for inhibiting the U-shaped torsion spring 7 from moving toward the axial first side of the platen roller 4 (along arrow A1) is provided in the vicinity of the contact portion 2n of the groove portion 2j as shown in FIG. 5. According to this embodiment, a length L in a protruding direction of the protrusion 20 is so formed as to be lager than a wire diameter D of the U-shaped torsion spring 7. The protrusion 20 is provided on a first inner surface of the groove portion 2j, and the length L in the protruding direction of the protrusion 20 is so adjusted as to have a clearance W larger than the wire diameter D of the U-shaped torsion spring 7 between the protrusion 20 and a second inner surface opposite to the protrusion 20.

As shown in FIG. 9, the groove portion 2j has a portion 2p not penetrating the first side plate 2 (see FIG. 5).

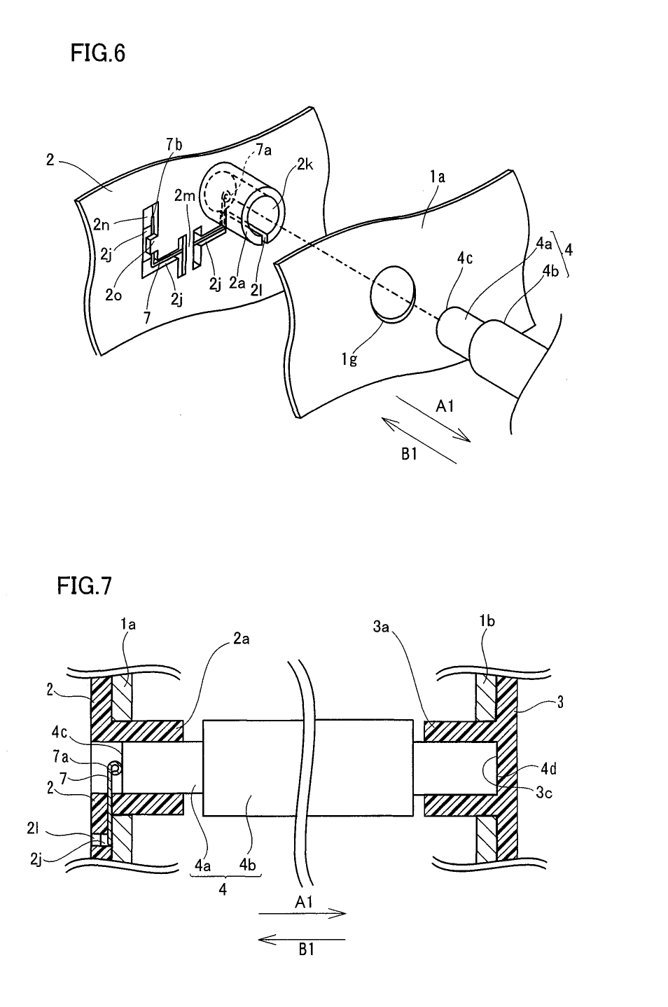

As shown in FIG. 6, the platen roller 4 is rotatably supported by the platen roller bearing 2a of the first side plate 2 and the platen roller bearing 3a of the second side plate 3. The platen roller bearings 2a and 3a are so arranged as to penetrate the first and second side surfaces 1a and 1b of the chassis respectively. A first end surface 4c of the shaft portion 4a of the platen roller 4 is urged toward the axial first side of the platen roller 4 (along arrow A1) by the first end 7a of the U-shaped torsion spring 7. A second end surface 4d of the shaft portion 4a of the platen roller 4 comes into contact with an inner wall surface 3c of the platen roller bearing 3a of the second side plate 3.

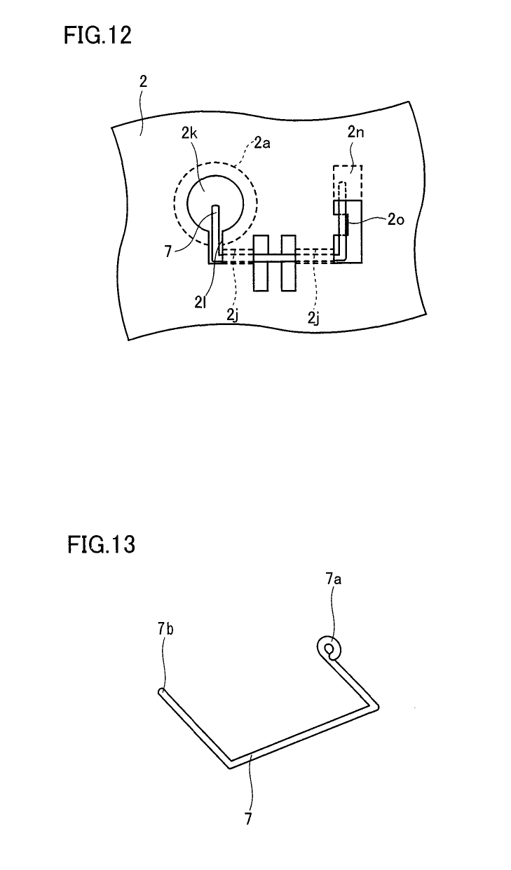

The U-shaped torsion spring 7 is supported by the coupling portion 2m and the groove portion 2j. As shown in FIG. 12, the U-shaped torsion spring 7 is formed by a metal spring member. According to this embodiment, the first end 7a of the U-shaped torsion spring 7 is formed in an annular shape by rounding its forward end. On the other hand, the second end 7b of the U-shaped torsion spring 7 is formed in a linear shape.

As shown in FIGS. 1 and 2, the print head 6 has a pair of support shafts 6a, a head portion 6b opposed to the platen roller 4, a pair of arms 6c coupling the support shafts 6a and the head portion 6b with each other. This print head 6 is rendered rotatable about the support shafts 6a. In other words, the pair of support shafts 6a of the print head 6 are rotatably mounted on the first and second side surfaces 1a and 1b of the chassis 1 respectively.

A description will be now made of a procedure for mounting the U-shaped torsion spring 7 on the groove portion 2j with reference to FIGS. 5, 14 and 15.

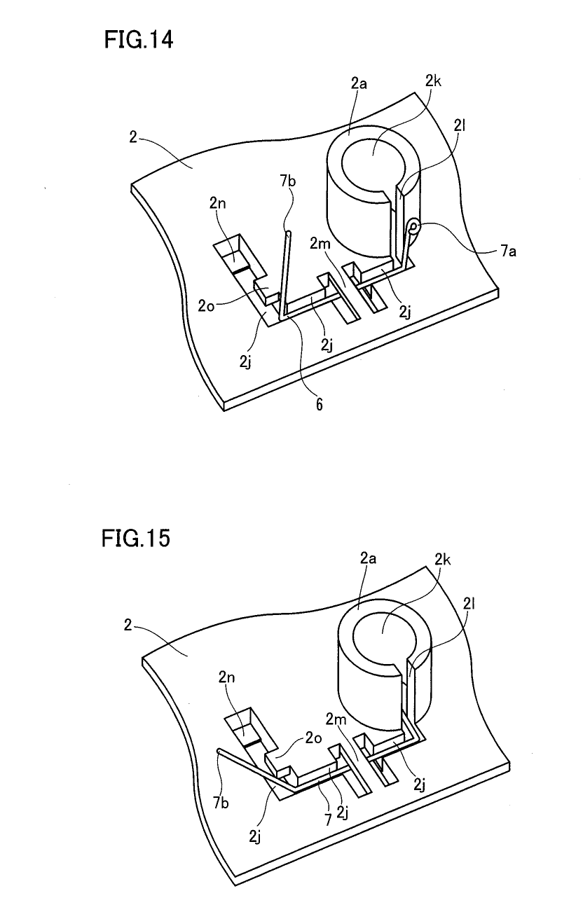

As shown in FIG. 14, the second end 7b of the U-shaped torsion spring 7 is passed through the coupling portion 2m of the groove portion 2j so that the U-shaped torsion spring 7 is stored in groove portion 2j. Thereafter the second end 7b of the U-shaped torsion spring 7 is opened outward and the second end 7b of the torsion spring 7 is inserted under the protrusion 20 from the outside while bringing the U-shaped torsion spring 7 down toward the first side plate 2, and then the second end 7b of the U-shaped torsion spring 7 is stored in the groove portion 2j, as shown in FIG. 15 from a state shown in FIG. 14. At this time, the first end 7a of the U-shaped torsion spring 7 is stored in the hole 2k of the platen roller bearing 2a through the slit 21 of the platen roller bearing 2a. Thus, as shown in FIG. 5, the U-shaped torsion spring 7 is completely stored in the groove portion 2j.

The thermal transfer printer 100 according to this embodiment prints characters (pictures) by thermally transferring an ink sheet 51 to a paper 60 with the print head 6 while holding the paper 60 and the ink sheet 51 between the platen roller 4 and the head portion 6b, as shown in FIG. 2.

According to this embodiment, as hereinabove described, the U-shaped torsion spring 7 for urging the shaft of the platen roller 4 toward the axial first side is mounted on the first side plate 2 integrally provided with the platen roller bearing 2a supporting the shaft portion 4a of the platen roller 4, whereby the U-shaped torsion spring 7 urges the shaft portion 4a of the platen roller 4 toward the axial first side while the platen roller bearing 2a of the first side plate 2 supports the shaft of the platen roller 4. Thus, the platen roller 4 can be easily located in the axial direction. Additionally, the first side plate 2 includes the groove portion 2j storing the U-shaped torsion spring 7 and linked to the hole 2k of the platen roller bearing 2a so that the U-shaped torsion spring 7 stored in the groove portion 2j urges the platen roller 4, whereby a portion at which the platen roller 4 is urged (torsion spring) can be inhibited from protruding outside the first side plate 2. Thus, the apparatus can be inhibited from being increased in size. Further, the groove portion 2j fixing the U-shaped torsion spring 7 integrally includes the first side plate 2, whereby no member for fixing the U-shaped torsion spring 7 may be separately provided. Thus, the number of components for urging the platen roller 4 can be reduced. Furthermore, the first side plate 2 includes the coupling portion 2m covering the opening of the groove portion 2j so as to form the through hole receiving the U-shaped torsion spring 7, whereby the U-shaped torsion spring 7 is mounted by passing the same through the coupling portion 2m. Thus, the coupling portion 2m can inhibit the U-shaped torsion spring 7 from dropping.

According to this embodiment, as hereinabove described, the coupling portion 2m is so formed as to be arranged at the position opposite to the vicinity of the center of the U-shaped torsion spring 7 when the U-shaped torsion spring 7 is stored in the groove portion 2j, whereby the coupling portion 2m and the vicinity of the center of the U-shaped torsion spring 7 are opposed to each other. Thus, the U-shaped torsion spring 7 can be inhibited from dropping from the opening of the groove portion 2j due to an impact such as drop.

According to this embodiment, as hereinabove described, the contact portion 2n is provided at the portion of the groove portion 2j where at least the second end 7b of the U-shaped torsion spring 7 is arranged, whereby the contact portion 2n receives force applied to the second end 7b of the U-shaped torsion spring 7 also in the case where force running axially outward (toward axial second side) is applied to the second end 7b of the U-shaped torsion spring 7 following the application of force running axially outward from the platen roller 4 to the first end 7a of the U-shaped torsion spring 7 due to an impact such as drop. Thus, the second end 7b of the U-shaped torsion spring 7 can be inhibited from moving toward the axial second side of the platen roller 4 to drop.

According to this embodiment, as hereinabove described, the contact portion 2n is formed in a plate shape so as to cover the opening of the groove portion 2j in the vicinity of the second end 7b of the U-shaped torsion spring 7, whereby the second end 7b of the U-shaped torsion spring 7 can be easily inhibited from moving toward the axial second side of the platen roller 4 to drop.

According to this embodiment, as hereinabove described, the protrusion 2o for inhibiting the U-shaped torsion spring 7 from moving toward the axial first side of the platen roller 4 is provided in the vicinity of the contact portion 2n of the groove portion 2j, whereby the portion in the vicinity of the second end 7b of the U-shaped torsion spring 7 is supported so as to be held between the protrusion 20 and the contact portion 2n. Thus, the second end 7b of the U-shaped torsion spring 7 can be inhibited from slipping off from the groove portion 2j.

According to this embodiment, as hereinabove described, the length L in the protruding direction of the protrusion 20 is so formed as to be larger than the wire diameter D of the U-shaped torsion spring 7, whereby the U-shaped torsion spring 7 can be easily inhibited from dropping over the protrusion 20.

According to this embodiment, as hereinabove described, the protrusion 2o is provided on the first inner surface of the groove portion 2j, and the length L in the protruding direction of the protrusion 2o is so adjusted as to have the clearance W larger than the wire diameter D of the U-shaped torsion spring 7 between the protrusion 2o and the second inner surface opposite to the protrusion 2o, whereby the U-shaped torsion spring 7 can be stored in the groove portion 2j through the clearance W due to the existence of the clearance W larger than at least the wire diameter D of the U-shaped torsion spring 7 between the protrusion 2o and the second inner surface opposite to the protrusion 2o.

According to this embodiment, as hereinabove described, the portion of the first end 7a of the U-shaped torsion spring 7 coming into contact with the first end surface 4c of the shaft portion 4a of the platen roller 4 is formed in an annular shape, whereby strength of the portion of the U-shaped torsion spring 7 coming into contact with the platen roller 4 can be improved due to the annular portion.

According to this embodiment, as hereinabove described, the second end 7b of the U-shaped torsion spring 7 is formed in a linear shape, whereby the second end 7b of the U-shaped torsion spring 7 can be passed through the through hole formed between the opening of the groove portion 2j and the coupling portion 2m. Thus, the U-shaped torsion spring 7 can be easily stored in the groove portion 2j.

Although the present invention has been described and illustrated in detail, it is clearly understood that the same is by way of illustration and example only and is not to be taken by way of limitation, the spirit and scope of the present invention being limited only by the terms of the appended claims.

For example, while the aforementioned embodiment is applied to the thermal transfer printer employed as an exemplary image generating apparatus, the present invention is not restricted to this but is also applicable to another image generating apparatus other than the thermal transfer printer so far as the same has the roller.

While the portion of the first end of the U-shaped torsion spring coming into contact with the shaft portion of the platen roller is formed in the annular shape in the aforementioned embodiment, the present invention is not restricted to this but the portion may be formed in a shape other than the annular shape so far as the strength of the U-shaped torsion spring can be increased. Alternatively, the portion of the first end of the U-shaped torsion spring coming into contact with the shaft portion of the platen roller may be formed in a linear shape.

What is claimed is:

1. An image generating apparatus comprising:
a chassis mounted with a print head;
a platen roller against which said print head is pressed;
a side plate mounted on a side surface of said chassis and integrally provided with a bearing supporting a shaft of said platen roller; and
a U-shaped torsion spring for urging said shaft of said platen roller toward an axial first side, mounted on said side plate, wherein
said side plate integrally includes a groove portion storing said U-shaped torsion spring and linked to a hole of said bearing, and a coupling portion covering an opening of said groove portion such that a through hole receiving said U-shaped torsion spring is formed by said coupling portion and said groove portion.

2. The image generating apparatus according to claim 1, wherein
said coupling portion is so formed as to be arranged at a position opposed to the vicinity of the center of said U-shaped torsion spring when said U-shaped torsion spring is stored in said groove portion.

3. The image generating apparatus according to claim 1, wherein
a first end of said U-shaped torsion spring is arranged in said hole of said bearing, while a second end of said U-shaped torsion spring is arranged in said groove portion, and
a contact portion for inhibiting said second end of said U-shaped torsion spring from moving toward an axial second side of said platen roller is provided at a portion of said groove portion at which at least said second end of said U-shaped torsion spring is arranged.

4. The image generating apparatus according to claim 3, wherein
said contact portion is formed in a plate shape so as to cover an opening of said groove portion in the vicinity of said second end of said U-shaped torsion spring.

5. The image generating apparatus according to claim 3, wherein
a protrusion for inhibiting said U-shaped torsion spring from moving toward said axial first side of said platen roller is provided in the vicinity of said contact portion of said groove portion.

6. The image generating apparatus according to claim 5, wherein
the length in a protruding direction of said protrusion is so formed as to be larger than at least the wire diameter of said U-shaped torsion spring.

7. The image generating apparatus according to claim 6, wherein
said protrusion is provided on a first inner surface of said groove portion, and
the length in a protruding direction of said protrusion is so adjusted as to have a clearance larger than at least said wire diameter of said U-shaped torsion spring between said protrusion and a second inner surface opposite to said protrusion.

8. The image generating apparatus according to claim 1, wherein
a portion of a first end of said U-shaped torsion spring coming into contact with said shaft of said platen roller is formed in an annular shape.

9. The image generating apparatus according to claim 1, wherein
a second end of said U-shaped torsion spring is formed in a linear shape.

10. An image generating apparatus comprising:
a chassis mounted with a print head;
a platen roller against which said print head is pressed;
a side plate mounted on a side surface of said chassis and integrally provided with a bearing supporting a shaft of said platen roller; and
a U-shaped torsion spring for urging said shaft of said platen roller toward an axial first side, mounted on said side plate, wherein
said side plate integrally includes a groove portion storing said U-shaped torsion spring and linked to a hole of said bearing, and a coupling portion covering an opening of said groove portion such that a through hole receiving said U-shaped torsion spring is formed by said coupling portion and said groove portion,
a first end of said U-shaped torsion spring is arranged in said hole of said bearing, while a second end of said U-shaped torsion spring is arranged in said groove portion,
a contact portion for inhibiting said second end of said U-shaped torsion spring from moving toward an axial second side of said platen roller is provided at a portion of said groove portion at which at least said second end of said U-shaped torsion spring is arranged,
a protrusion for inhibiting said U-shaped torsion spring from moving toward said axial first side of said platen roller is provided in the vicinity of said contact portion of said groove portion, and
a portion of a first end of said U-shaped torsion spring coming into contact with said shaft of said platen roller is formed in an annular shape.

11. The image generating apparatus according to claim 10, wherein
said coupling portion is so formed as to be arranged at a position opposed to the vicinity of the center of said U-shaped torsion spring when said U-shaped torsion spring is stored in said groove portion.

12. The image generating apparatus according to claim 10, wherein
said contact portion is formed in a plate shape so as to cover an opening of said groove portion in the vicinity of said second end of said U-shaped torsion spring.

13. The image generating apparatus according to claim 10, wherein
the length in a protruding direction of said protrusion is so formed as to be larger than at least the wire diameter of said U-shaped torsion spring.

14. The image generating apparatus according to claim 13, wherein
said protrusion is provided on a first inner surface of said groove portion, and
the length in a protruding direction of said protrusion is so adjusted as to have a clearance larger than at least said wire diameter of said U-shaped torsion spring between said protrusion and a second inner surface opposite to said protrusion.

15. The image generating apparatus according to claim 10, wherein
said second end of said U-shaped torsion spring is formed in a linear shape.
